(19) United States
(12) Patent Application Publication
(10) Pub. No.: US 2026/0102881 A1
(43) Pub. Date: Apr. 16, 2026

(54) Lightweight ratchet wrench structure

(71) Applicant: GONG FONG ENTERPRISE CO., LTD., Tainan City (TW)

(72) Inventor: CHE-I HU, Tainan City (TW)

(21) Appl. No.: 19/032,011

(22) Filed: Jan. 18, 2025

(30) Foreign Application Priority Data
Oct. 16, 2024 (TW) 113139379

(51) Int. Cl. B25B 13/46

(52) U.S. Cl. CPC B25B 13/463

(57) ABSTRACT

A lightweight ratchet wrench structure has a wench body, a ratchet member, a ratchet seat and a switch member. The wench body is made of lightweight material, which can significantly reduce the weight of the ratchet wrench. When the ratchet member is assembled into a containing slot of the wench body, a flat section is provided to contact the inner wall of the containing slot to form a rotation. It can not only greatly improve the smoothness of the ratchet member rotation, but also prevent the toothed section from contacting and rubbing the inner wall of the containing slot, thus preventing the containing slot from being damaged due to the force of the ratchet member. The ratchet seat is provided with a ratchet block engaging with the ratchet member, thereby preventing the ratchet block from directly rubbing against the inner wall of the ratchet slot.

### BACKGROUND OF THE INVENTION

### Field of Invention

The present invention relates to a lightweight ratchet wrench structure.

### Description of the Related Art

According to the traditional ratchet wench body structure, it is generally made of steel, iron and other materials with high specific gravity, good rigidity and high torque resistance. However, the tool body made of such materials is heavy and difficult to grasp, and long-term operation can easily cause hand soreness or injury; Therefore, in order to improve the disadvantage of the traditional ratchet wrench being heavy. There is a lightweight ratchet wrench on the market, such as the “ratchet wrench structure” of Taiwan patent No. I505915. This patent relates to a ratchet wrench structure, and more particularly to a ratchet wrench structure in which the first body is made of a light metal or plastic material, and the second body is made of a strong metal. The second body can withstand a greater rotational torque, thereby reducing the weight of the overall structure of the ratchet wrench.

Therefore, it is desirable to provide a lightweight ratchet wrench structure to mitigate and/or obviate the aforementioned problems.

### SUMMARY OF THE INVENTION

An objective of present invention is to provide a lightweight ratchet wrench structure, which is capable of improving the above-mention problems.

In order to achieve the above-mentioned objective, a lightweight ratchet wrench structure includes a wench body, a ratchet member, a ratchet seat and a switch member. The wench body is made of lightweight material, which can significantly reduce the weight of the ratchet wrench. When the ratchet member is assembled into a containing slot of the wench body, a flat section is provided to contact the inner wall of the containing slot to form a rotation. It can not only greatly improve the smoothness of the ratchet member rotation, but also prevent the toothed section from contacting and rubbing the inner wall of the containing slot, thus preventing the containing slot from being damaged due to the force of the ratchet member. The ratchet seat is provided with a ratchet block engaging with the ratchet member, thereby preventing the ratchet block from directly rubbing against the inner wall of the ratchet slot.

Other objects, advantages, and novel features of invention will become more apparent from the following detailed description when taken in conjunction with the accompanying drawings.

### BRIEF DESCRIPTION OF THE DRAWINGS

FIG. 1 is a three-dimensional view of a preferred embodiment according to the present invention.

FIG. 2 is an exploded view of the preferred embodiment according to the present invention.

FIG. 3 is a combined sectional view of the preferred embodiment according to the present invention.

FIG. 4 is a state drawing of the counterclockwise rotation of the present invention.

FIG. 5 is a cross-sectional view of the counterclockwise rotation of the preferred embodiment according to the present invention.

FIG. 6 is a partial enlarged cross-sectional view of the counterclockwise rotation of the preferred embodiment according to the present invention.

FIG. 7 is a state drawing of the clockwise rotation of the preferred embodiment according to the present invention.

FIG. 8 is a cross-sectional view of the clockwise rotation of the preferred embodiment according to the present invention

### DETAILED DESCRIPTION OF PREFERRED EMBODIMENT

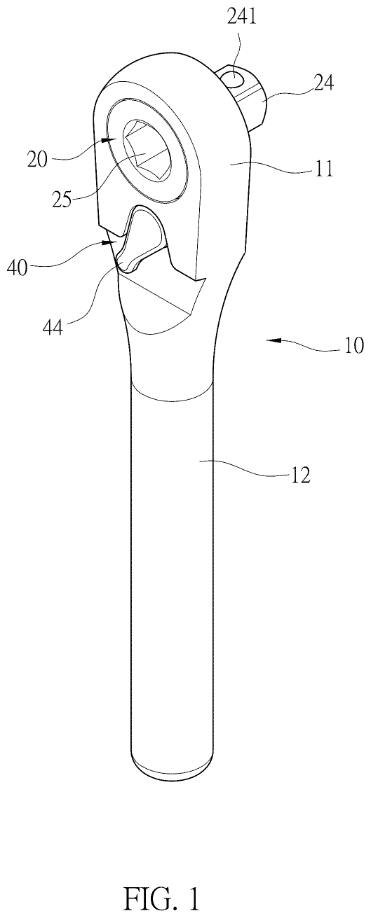

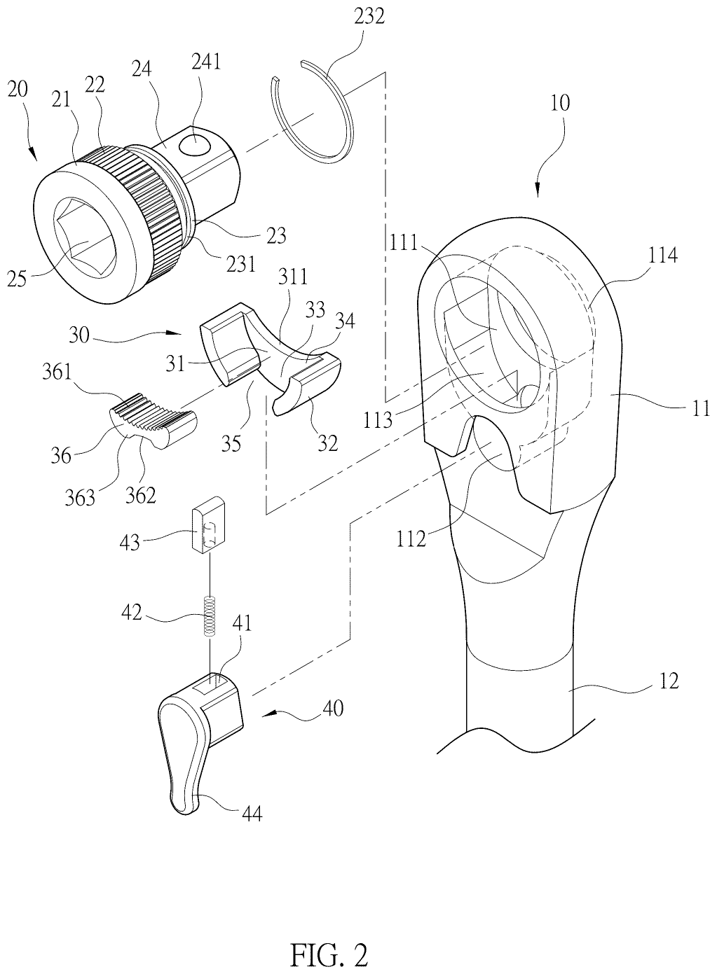

First, please refer to FIGS. 1 and 2. A lightweight ratchet wrench structure comprises a wench body 10, a ratchet member 20, a ratchet seat 30 and a switch member 40. The wench body 10 is made of a lightweight metal and has a head portion 11 and a handle portion 12. The head portion comprises a containing slot 111, a controlling slot 112, and a ratchet slot 113 between the containing slot 111 and the controlling slot 112. The containing slot 111 is a round hole and disposed through two opposite sides of the head portion 11, and has a tapered limiting opening 114 at one opened end. The controlling slot 112 is disposed at one side of the head portion 11 and have a closed bottom. The ratchet slot 113 is an arc-shaped space and connects the containing slot 111 and the controlling slot 112. The ratchet member 20 is mounted in the containing slot 111 of the wench body 10, an outer edge of the ratchet member 20 has a flat section 21 and a toothed section 22, the flat section 21 is higher than the toothed section 22 and contacts an inner wall of the containing slot 111, such that the toothed section 22 makes no contact with the inner wall of the containing slot 111. Furthermore, one end of the ratchet member 20 is narrowed to form an assembling column 23 protruding from the limiting opening 114 and having a ring groove 231 engaged with a C-shaped hook 232. A free end of assembling column 23 further comprises a stopping column 24, the stopping column 24 is non-cylindrical and has a snap bead 241, and another end of the ratchet member 20 further comprises a non-circular inner concave hole 25 for various purposes. The ratchet seat 30 is mounted in the ratchet slot 113 and has a bottom wall 31 with two limiting edges 32, and each of the two limiting edge 32 is curved and abuts against the inner wall of the ratchet slot 113. A tapered sliding slot 33 is disposed between the two limiting edges 32 and has an upper opening 34 facing the containing slot 112 and a lower opening 35 being smaller than the upper opening 34 and facing the controlling slot 112. In addition, he end edge of the bottom wall 31 having the upper opening 34 is formed with a concave arc portion 311. The sliding slot 33 is configured for accepting the ratchet block 36. One end of the ratchet block 36 facing the upper opening 34 comprises a plurality of ratchet teeth 361, another end of the ratchet block 36 facing the lower opening 35 has a concave bottom 362 with a stopping portion 363 on both opposite sides respectively. The switch member 40 is mounted in the controlling slot 112, one end of the switch member 40 has a through slot 41 sequentially assembled with a elastic member 42 and a top column 43, so that the top column 43 is pushed through the through slot 41 by the elastic member 42, and the switch member 40 further comprises a trigger 44 outside of the controlling slot 112.

Furthermore, a ratio between the flat section 21 and the toothed section 22 of the ratchet member 20 is at least 1:2, in other words, the area of the toothed section 22 is twice than the area of the flat section 21, and ratio is at most 1:1, in other words, the area of the toothed section 22 is equal to the area of the flat section 21.

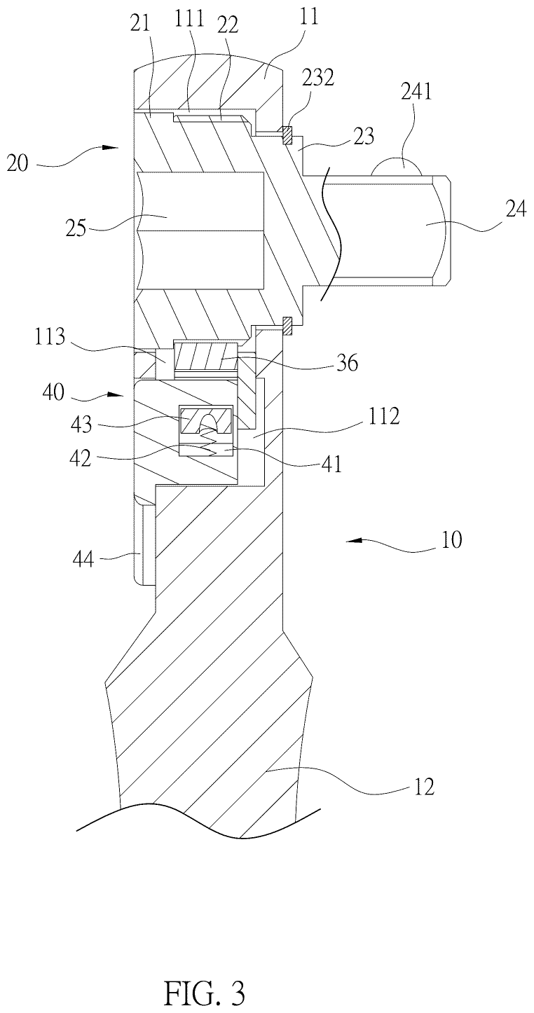

The structure assembly, as shown in FIGS. 1, 2, 3 and 5, the ratchet seat 30 is firstly configured with the ratchet block 36 disposed through the sliding slot 33, and then the ratchet seat 30 is placed into the ratchet slot 113 through the containing slot 111, and the limiting edge 32 on both opposite sides of the ratchet seat 30 aligned with the two side walls of the containing slot 111. Then the ratchet member 20 is assembled into the containing slot 111, The flat section 21 of the ratchet member 20 is in rotatable contact with the inner wall of the containing slot 111, and some lubricant can be added to improve the smoothness of the rotation of the ratchet member 20 in the containing slot 111. The assembling column 23 and the stopping column 24 are inserted through the limiting opening 114 and then the C-shaped hook 232 is engaged with the ring groove 231 of the assembling column 23. Afterward, the C-shaped hook 232 presses against the edge of the limiting opening 114 to limit the ratchet member 20, then finally the switch member 40 is assembled into the controlling slot 112. The elastic member 42 and one end of the top column 43 pass through the lower opening 35 and abut the concave bottom 362 of the ratchet block 36 to move the ratchet block 36 upwardly, so that the end edges of the ratchet tooth 361 of the ratchet block 36 protrude from the upper opening 34 and engage with the toothed section 22 of the ratchet member 20, and the switch member 40 is driven by the rotation of the trigger 44 to push the ratchet block 36 to move laterally in the sliding slot 33, and then the top column 43 pushes against one of the stopping portions 363 to form a stop, thereby achieving a single-direction ratcheting operation and completing the assembly of the ratchet wrench.

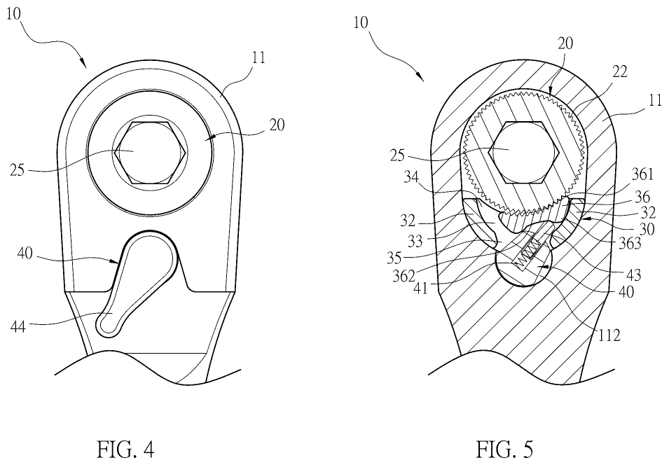

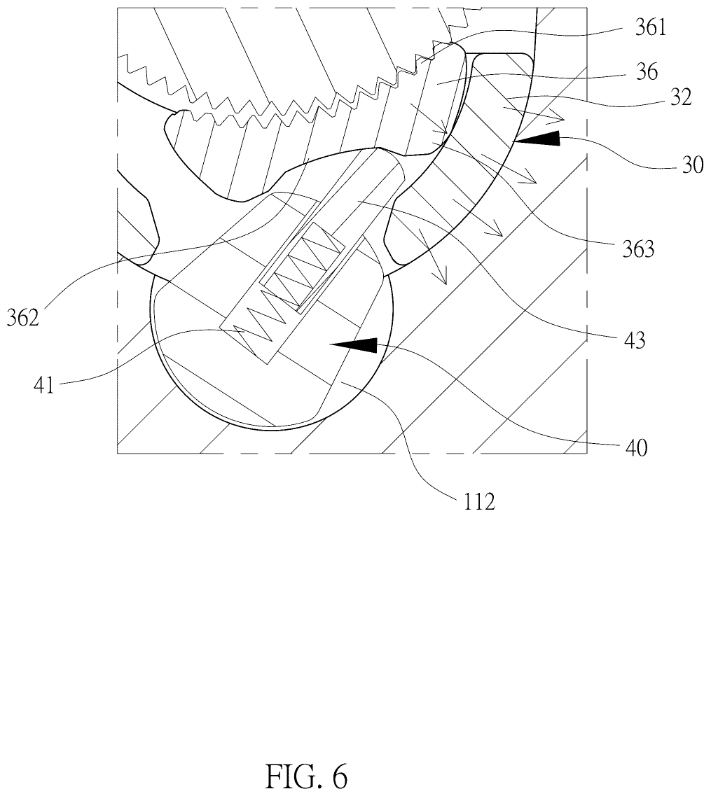

Please refer to FIGS. 4 and 5. When the switch member 40 is turned to a first position and driving the ratchet block 36 to move, if the user wants to tighten or loosen the workpiece, the trigger 44 of the switch member 40 is toggled to the left, the switch member 40 abuts against the stopping portion 363 through the top column 43 on the right side of the concave bottom 362, and pushes the ratchet block 36 to move to the right so that the right end edge of the ratchet block 36 abuts close to the limiting edge 32 on the right side of the ratchet seat 30 for positioning. Thereby, the ratchet teeth 361 on the right end of the ratchet block 36 engage with The toothed section 22 of the ratchet member 20, which makes the ratchet member 30 to lock with the ratchet block 40 during the counterclockwise rotation, so that the wench body 10 is capable of performing counterclockwise tightening operation. As shown in FIG. 6, the top column 43 pushes against the ratchet block 36 to form a positioned status, and the ratchet block 36 applies a single point force on the limiting edge 32, then the force is dispersed and evenly transmitted to the inner wall of the ratchet slot 113 through the limiting edge 32, so as to avoid the situation that the ratchet slot 113 is damaged and deformed due to a single point force, which helps to improve the durability of the wench body 10. Furthermore, when the wench body 10 is rotated clockwise, the toothed section 22 of the ratchet member 20 pushes the ratchet block 36 downward and squeezes the elastic member 42 for disengagement, so that the wench body 10 can be turned back to facilitate repeated counterclockwise rotation operations.

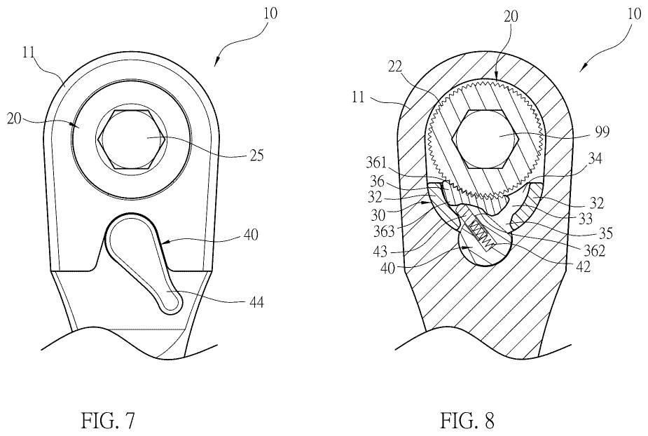

Continuing with FIGS. 7 and 8, the switch member 40 is toggled to a second position and drives the ratchet block 36 to move to a second position, when the user wants to tighten or loosen the workpiece clockwise, the trigger 44 of the switch member 40 is toggled to the right, the top column 43 of the switch member 40 abuts against the stopping portion 363 on the left side of the concave bottom 362 and pushes the ratchet block 36 to move to the left, so that the left end edge of the ratchet block 36 abuts close to the limiting edge 32 on the left side of the ratchet seat 30 to form a positioned status. Therefore, the ratchet teeth 361 of the left end of the ratchet block 36 engage with the toothed section 22 of the ratchet member 20, which makes the ratchet member 30 lock with the ratchet block 40 when the ratchet member 30 rotates clockwise, so that the wench body 10 can be turned clockwise for the tightening operation. On the contrary, when the ratchet member 30 rotates counterclockwise, the ratchet The toothed section 22 of the member 20 pushes the ratchet block 36 downward and squeezes the elastic member 42 to escape, so that the wench body 10 can be turned back to facilitate repeated clockwise rotation operations.

The structure of the above mentioned embodiment can provide the following benefits: (a) the wench body 10 of the present invention is made of a lightweight metal material, which can significantly reduce the weight of the ratchet wrench, making it easier for users to carry and use it; also, the ratchet member 20 is assembled into the containing slot 111 of the wench body 10, the flat section 21 contacts the inner wall of the containing slot 111 and rotates, which can not only greatly improve the smoothness of the rotation of the ratchet member 20, but also prevent the toothed section 22 contacts and rubs against the inner wall of the containing slot 111, so as to prevent the containing slot 111 from being damaged by the friction of the toothed section 22 due to the force applied by the ratchet member 20, thereby ensuring the integrity of the containing slot 111 and improving the durability of the wench body.

(ii) The ratchet slot 113 is assembled with the ratchet seat 30 for accommodating the ratchet block 36, since the ratchet block 36 needs to engage with the ratchet member 20, its strength and hardness are higher than the wench body 10. When the ratchet block 36 moves along the sliding slot 33 of the ratchet seat 30, the force of the ratchet block 36 is fully applied to the ratchet seat 30, which can not only prevent the ratchet block 36 from directly rubbing against and pressing against the inner wall of the ratchet slot 113, but the ratchet seat 30 also contacts the inner wall of the ratchet slot 113 in a full flat contact, thereby preventing the ratchet slot 113 from being damaged or deformed, and improving the engagement stability between the ratchet block 36 and the ratchet member 20.

(iii) Furthermore, the ratchet seat 30 is designed to only be assembled into the ratchet slot 113 and effectively protect the ratchet slot 113 from the friction and abutment of the ratchet block 36, so that the volume of the ratchet seat 30 can be reduced, which helps to reduce the weight of wench body 10, and the head portion 11 of the wench body 10 does not need to be additionally enlarged due to the placement of the ratchet seat 30, so as to achieve the purpose of lightweighting the ratchet wrench 10. The limiting edges 32 are in contact with the inner wall plane of the ratchet slot 113. Moreover, the ratchet seat 30 is hidden in the ratchet slot 113 and contacts the inner wall plane of the ratchet slot 113 through the two limiting edges 32, which helps to improve the stability of the ratchet wrench structure.

Although the present invention has been explained in relation to its preferred embodiment, it is to be understood that many other possible modifications and variations can be made without departing from the spirit and scope of invention as hereinafter claimed.

What is claimed is:

1. A lightweight ratchet wrench structure comprising:
a wench body made of a lightweight metal and having a head portion and a handle portion; the head portion comprising a containing slot, a controlling slot, and a ratchet slot between the containing slot and the controlling slot; the containing slot disposed through two opposite sides of the head portion and having a limiting opening at one opened end;
a ratchet member mounted in the containing slot of the wench body, an outer edge of the ratchet member having a flat section and a toothed section, the flat section being higher than the toothed section and contacting an inner wall of the containing slot; one end of the ratchet member having an assembling column protruding from the limiting opening and having a ring groove engaged with a C-shaped hook;
a ratchet seat mounted in the ratchet slot and having a bottom wall with two limiting edges, a tapered sliding slot disposed between the two limiting edges and having an upper opening facing the containing slot and a lower opening being smaller than the upper opening and facing the controlling slot, the sliding slot accepting a ratchet block;
a switch member mounted in the controlling slot, one end of the switch member passing through the lower opening and abutting the ratchet block, such that a top edge of the ratchet block protrudes from the upper opening and engages with the toothed section of the ratchet member; the switch member further comprising a trigger outside of the controlling slot, configured for driving the switch member to rotate, to cause the ratchet block to slide along the sliding slot.

2. The lightweight ratchet wrench structure as claimed in claim 1, wherein the ratchet slot is an arc-shaped space, the two limiting edges of the ratchet seat are arc-shaped and abut against an inner wall of the ratchet slot, and a bottom wall edge of an upper opening of the ratchet seat forms a concave arc portion.

3. The lightweight ratchet wrench structure as claimed in claim 1, wherein the ratchet member has a stopping column protruding from an edge of the assembling column, the stopping column is non-cylindrical and has a snap bead on one side, and another end of the ratchet member further comprises a non-circular inner concave hole.

4. The lightweight ratchet wrench structure as claimed in claim 1, wherein a ratio between the flat section and the toothed section of the ratchet member is at least 1:2 and at most 1:1.

5. The lightweight ratchet wrench structure as claimed in claim 1, wherein one end of the ratchet block facing the upper opening comprises a plurality of ratchet teeth corresponding with the toothed sections of the ratchet member, and another end of the ratchet block facing the lower opening comprises a concave bottom with a stopping portion on both opposite sides respectively.

6. The lightweight ratchet wrench structure as claimed in claim 1, wherein the switch member has a through slot at an end passing through the lower opening, and the through slot is sequentially assembled with an elastic member and a top column, so that the top column is pushed through the through slot by the elastic member, the top column pressing against the concave bottom of the ratchet block, and one of the stopping portions is pushed by the rotation of the switch member.
